(19) United States
(12) Patent Application Publication
(10) Pub. No.: US 2016/0339840 A1
(43) Pub. Date: Nov. 24, 2016

(54) METHOD AND APPARATUS FOR ASSISTING A MANEUVERING PROCEDURE OF A VEHICLE

(71) Applicant: FORD GLOBAL TECHNOLOGIES, LLC, Dearborn, MI (US)

(72) Inventors: Frederic STEFAN, Aachen (DE); Uwe GUSSEN, Huertgenwald (DE); Christoph ARNDT, Moerlen Rheinland-Pfalz (DE)

(21) Appl. No.: 15/160,886

(22) Filed: May 20, 2016

(30) Foreign Application Priority Data
May 22, 2015 (DE) 10 2015 209 445.6

(51) Int. Cl. B60Q 9/00; B60R 1/00

(52) U.S. Cl. CPC B60Q 9/005; B60R 1/00

(57) ABSTRACT

The disclosure relates to a method and an apparatus for assisting a maneuvering procedure of a vehicle. In the course of a method for assisting a maneuvering procedure of a vehicle, image data relating to the environment of the vehicle are registered by using at least one vehicle-specific sensor provided on the vehicle, and on the basis of these image data a visual representation of the environment of the vehicle is transmitted to the driver, said method having the following steps: receiving further image data relating to the environment of the vehicle that were registered by at least one external sensor, linking the image data received from this external sensor with the image data registered by the at least one vehicle-specific sensor, and transmitting a visual representation of the environment of the vehicle to the driver on the basis of the linked image data.

### CROSS-REFERENCE TO RELATED APPLICATION

This application claims foreign priority benefits under 35 U.S.C. §119(a)-(d) to DE 10 2015 209 445.6, filed May 22, 2015, which is hereby incorporated by reference in its entirety.

### TECHNICAL FIELD

The invention relates to a method and an apparatus for assisting a maneuvering procedure of a vehicle.

### BACKGROUND

For the purpose of assisting the driver of a vehicle in the course of maneuvering procedures, in particular during the implementation of parking maneuvers, 360° camera systems have been developed by a range of manufacturers. Such systems typically possess a plurality of cameras, for example cameras in the exterior mirrors, rear-view cameras and front-view cameras. These cameras are activated in certain situations, the images supplied by the cameras being merged and utilized for the purpose of representing a view of the driver's own vehicle during the maneuvering with respect to the objects located in the environment of the vehicle and registered by the cameras.

Even though the camera systems described provide the driver with additional information about obstacles located in the vicinity, they exhibit various disadvantages. For example, in practice the case may arise that, due to the limited number of cameras as well as the position thereof within the vehicle, certain objects are not registered by the respective system or are only registered belatedly. Moreover, the generation of the 360° view frequently results in distortions in the representation after merging of the individual camera images, which under certain circumstances renders difficult the estimation of distances from a certain object or from a certain destination.

From DE 10 2013 204 843 A1, among other things a driver-assistance system is known that makes it possible to take account of no-stopping signs within the scope of an automated parking-assistant system. In this case a control unit may also have been set up to transmit the data with respect to the ascertained traffic sign to another vehicle located in the surroundings.

With regard to the further state of the art, reference is made, merely in an exemplary manner, to U.S. Pat. No. 7,782,227 B2 and U.S. Pat. No. 7,102,496 B1.

### SUMMARY

It is an object of the present invention to make available a method and an apparatus for assisting a maneuvering procedure of a vehicle that make possible a more reliable consideration of the environment of the vehicle.

This object is achieved by the method according to the features of the independent claim 1 and by the apparatus according to the features of the associated claim 10.

In the case of a method according to the invention for assisting a maneuvering procedure of a vehicle, image data relating to the environment of the vehicle are registered by using at least one vehicle-specific sensor provided on the vehicle, and on the basis of these image data a visual representation of the environment of the vehicle is transmitted to the driver, said method having the following steps:

receiving further image data relating to the environment of the vehicle, which were registered by at least one external sensor;

linking the image data received from this external sensor with the image data registered by the at least one vehicle-specific sensor; and

transmitting a visual representation of the environment of the vehicle to the driver on the basis of the linked image data.

The concept underlying the invention is, in particular, to utilize at least one external camera or at least one external visual sensor for a better consideration of the environment of the vehicle, for example for an improved 360° view. As a result, according to the invention the registration also of zones that are concealed for vehicle-specific sensors, a visual representation of the environment of the vehicle that is more accurate or burdened with fewer faults such as distortions, a more exact estimation of existing spacings from objects located in the environment of the vehicle and also, where appropriate, the more reliable generation of possible warning signals can be obtained.

According to an embodiment, the receiving and/or linking of the further image data takes place after automatic set-up of a wireless communication between the vehicle and the external sensor.

According to an embodiment, the receiving and/or linking of the further image data takes place only if the respective external sensor satisfies at least one predetermined criterion. The at least one predetermined criterion may be, in particular, a criterion relating to the relative position of the vehicle and the external sensor.

According to an embodiment, the at least one predetermined criterion has been selected from the following group:

existence of a direct line-of-sight connection between the vehicle and the external sensor;

suitability of the external sensor for wireless transmission of the image data received by this external sensor to the vehicle;

existence of a zone at least temporarily not capable of being registered by the at least one vehicle-specific sensor but capable of being registered by the external sensor.

According to an embodiment, the at least one external sensor is a sensor provided on a separate vehicle.

According to an embodiment, the at least one external sensor is a sensor provided on a traffic-infrastructure fixture.

According to an embodiment, the at least one external sensor is a sensor provided on a mobile communications device (for example, a smartphone).

According to an embodiment, the transmitting of the visual representation of the environment of the vehicle to the driver takes place in the form of a 360° view.

The invention further relates to an apparatus for assisting a maneuvering procedure of a vehicle, which has been configured to implement a method having the features described above. With regard to advantages and preferred configurations of the apparatus, reference is made to the above remarks in connection with the method according to the invention.

Further configurations of the invention are to be gathered from the description and also from the dependent claims.

The invention will be elucidated in more detail below on the basis of an exemplary embodiment with reference to the appended illustrations.

Shown are:

### BRIEF DESCRIPTION OF THE DRAWINGS

FIG. 1 a schematic representation of an exemplary scenario during the implementation of a maneuvering procedure; and

FIG. 2 a schematic overview of components that are present in an apparatus according to the invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

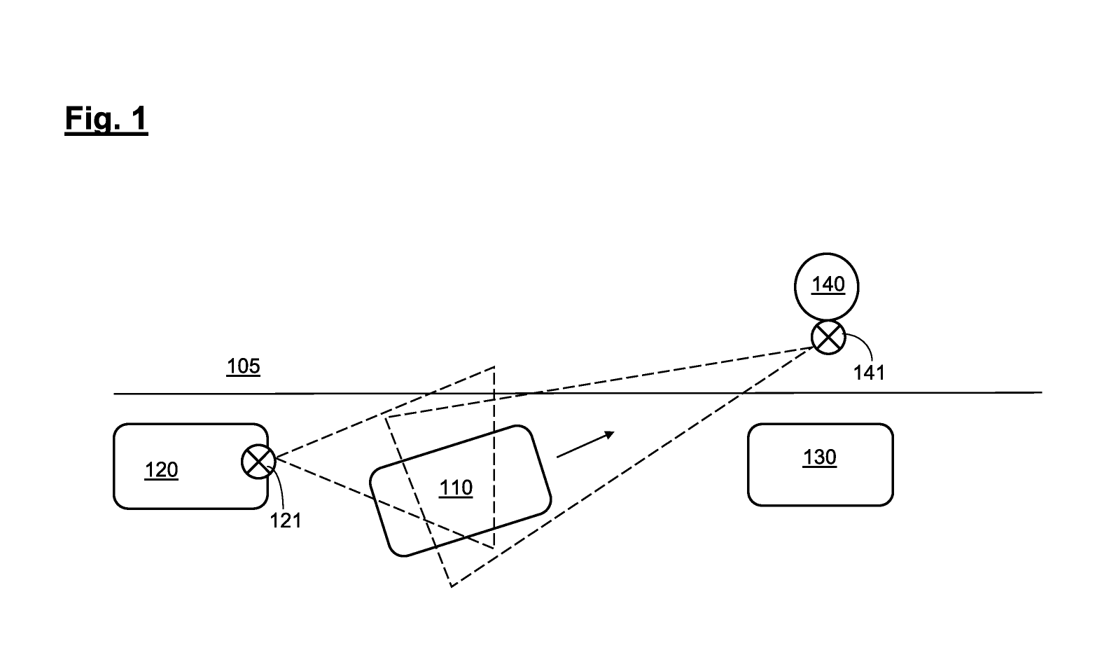

FIG. 1 shows, in merely schematic representation, an exemplary scenario during the implementation of a maneuvering procedure. According to FIG. 1, a vehicle 110 is carrying out a maneuvering procedure in the form of a parking procedure into a parking space between a separate vehicle 120 and a further separate vehicle 130. Now with the apparatus according to the invention it is registered that separate vehicle 120 is equipped with a visual sensor 121 in the form of a rear-view camera that is capable of transmitting recorded data via a vehicle-to-vehicle communication system, whereby, in addition, a good line-of-sight connection to vehicle 110 and to the maneuver carried out by vehicle 110 is ensured by the visual sensor 121 in question or by the rear-view camera that is present on separate vehicle 120. Moreover, according to FIG. 1 a traffic-infrastructure fixture 140 (in the example, in the form of a pillar located on the curb 105) is also equipped with a visual sensor 141, from which a good line-of-sight connection to vehicle 110 is likewise ensured.

The set-up now takes place of a communication link between the apparatus according to the invention in vehicle 110 and the two external visual sensors 121, 141 (that is to say, the rear-view camera on separate vehicle 120 and the camera that is present on the traffic-infrastructure fixture 140), as well as a linkage or merging of the images recorded by these external cameras with the vehicle-specific cameras (not represented) on vehicle 110, in order, for example, to improve the accuracy of a 360° view.

In this regard, diverse criteria that are to be satisfied by the external visual sensor in question may be drawn upon.

According to one criterion, it may be demanded that there is the possibility to transmit the images registered in the given case by the external visual sensor to the driver's own vehicle 110 equipped in accordance with the invention, which can take place, in particular, by means of a suitable vehicle-to-vehicle communication module, for example. Moreover, in this regard a power supply sufficient for the transmission of information may also be demanded.

Moreover, the fulfilment may be demanded of certain positional criteria that relate to the position of the respective external visual sensor. In this regard, in particular the existence of a direct line-of-sight connection between the external visual sensor and the driver's own vehicle, the existence of a line-of-sight connection from the external visual sensor to a zone located in the environment of the vehicle but not registered by the vehicle-specific sensors or cameras, the coverage either of a certain longitudinal or lateral section of the driver's own vehicle and/or a sufficient proximity of the external visual sensor to the driver's own vehicle (for the purpose of providing additional information for estimating the spacing from objects located in the environment of the driver's own vehicle) may be demanded.

According to a further criterion, it may be demanded that the relative position of the at least one external visual sensor with respect to the driver's own vehicle can be estimated.

The at least one external visual sensor utilized in accordance with the invention may have been provided on another vehicle, on an arbitrary traffic-infrastructure fixture or even on a mobile communications device such as a smartphone, for example.

If at least one suitable external visual sensor or an external camera exists, a communication link with the external sensor in question or with the external camera is set up, in order to obtain the view of the maneuvering environment generated by the external sensor in question or by the external camera. Given knowledge or assessment of the position of the external sensor in question or of the external camera, a linkage or merging of the additionally available external images in question with the image data recorded by the vehicle-specific cameras can then take place.

The activation of the apparatus according to the invention may be effected in various ways.

According to an embodiment, the activation of the apparatus according to the invention may be effected manually by the driver. Moreover, the activation may, where appropriate, be effected automatically as soon as the reverse gear is engaged, a driver-assistance system for assisting a parking maneuver or some other low-speed maneuver is activated, or if the speed of the vehicle falls below a predetermined threshold value.

Moreover, predetermined conditions may also exist for a deactivation of the apparatus according to the invention: for example, the non-fulfilment of all the activation conditions, or the completion of the respective maneuver (for example, switching the ignition off, standstill for a certain period of time etc.).

In further embodiments, a merging or linkage of the information received from the at least one external visual sensor with the information of other vehicle-specific sensors (for example, proximity sensors such as parking sensors) may also take place, in order to achieve an optimal imaging of the environment of vehicle 110.

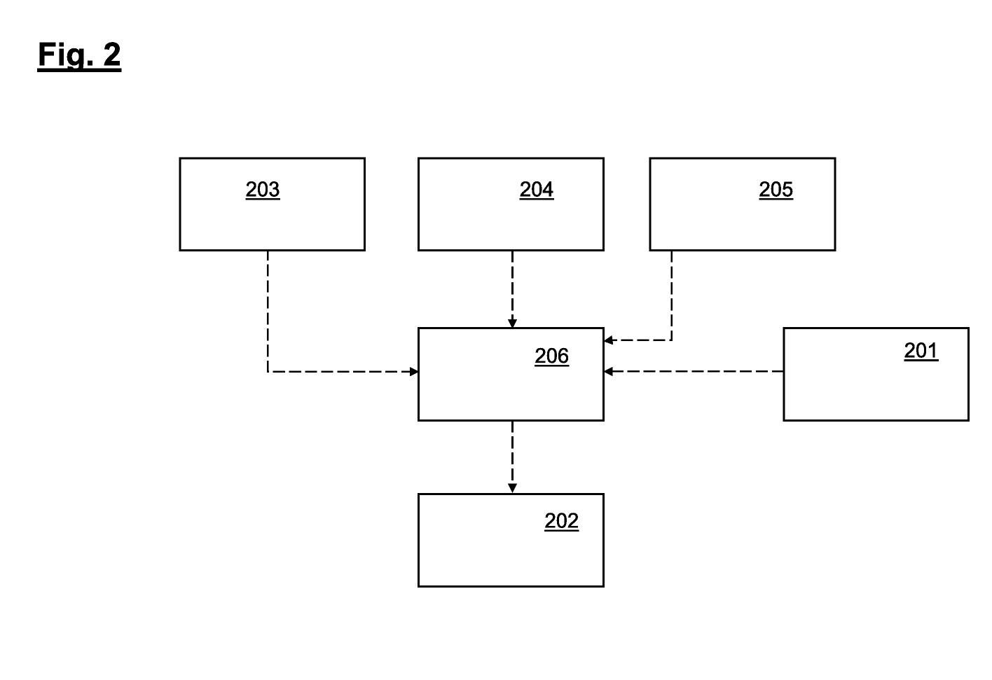

FIG. 2 shows, in merely schematic representation, an overview of components that are present in an apparatus according to the invention.

A control module 201 serves for activating and deactivating the apparatus according to the invention. The apparatus according to the invention exhibits a human/machine interface (HMI) 202 in the form of a display for representing a 360° view. In embodiments, the human/machine interface (HMI) 202 may also have been configured to specify or to represent the estimated spacing from a target position or from an obstacle on the basis of the displayed (camera) image.

Denoted by 203 is a module for registering the state of the vehicle, which makes information available about the current state of the vehicle (for example, current vehicle speed, gear position, activation state of the assistance system etc.). The apparatus according to the invention exhibits a module 204 for registering an external visual sensor or an external camera. This module 204 monitors the environment of the vehicle and registers external cameras located in the environment and ascertains furthermore which external camera(s) or sensor(s) can be used for assisting the apparatus according to the invention.

A communication module 205 serves for implementing the communication with one or more external visual sensors or cameras and is responsible for the reception of the images recorded by the respective external camera, inclusive of the (in particular, temporal) planning.

A processing unit or processor unit 206 links the external camera images with the images of the vehicle-specific cameras, in order to improve a top view (or a “‘bird’s-eye view”) of the driver's own vehicle and to indicate it on the HMI 202 or, to be specific, on the display.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for assisting a maneuvering procedure of a vehicle, wherein image data relating to the environment of the vehicle are registered by using at least one vehicle-specific sensor provided on the vehicle, and wherein on the basis of these image data a visual representation of the environment of the vehicle is transmitted to the driver, wherein the method has the following steps:
receiving further image data relating to the environment of the vehicle, which were registered by at least one external sensor;
linking the image data received from this external sensor with the image data registered by the at least one vehicle-specific sensor; and
transmitting a visual representation of the environment of the vehicle to the driver on the basis of the linked image data.

2. The method as claimed in claim 1, wherein the receiving or linking of the further image data takes place after automatic set-up of a wireless communication between the vehicle and the external sensor.

3. The method as claimed in claim 1, wherein the receiving or linking of the further image data takes place only if the respective external sensor satisfies at least one predetermined criterion.

4. The method as claimed in claim 3, wherein the at least one predetermined criterion is a criterion relating to the relative position of the vehicle and the external sensor.

5. The method as claimed in claim 3, wherein the at least one predetermined criterion has been selected from the following group:
existence of a direct line-of-sight connection between the vehicle and the external sensor;
suitability of the external sensor for wireless transmission of the image data received from this external sensor to the vehicle;
existence of a zone at least temporarily not capable of being registered by the at least one vehicle-specific sensor but capable of being registered by the external sensor.

6. The method as claimed in claim 1, wherein the at least one external sensor is a sensor provided on a separate vehicle.

7. The method as claimed in claim 1, wherein the at least one external sensor is a sensor provided on a traffic-infrastructure fixture.

8. The method as claimed in claim 1, wherein the at least one external sensor is a sensor provided on a mobile communications device.

9. The method as claimed in claim 1, wherein the transmitting of the visual representation of the environment of the vehicle to the driver takes place in the form of a 360° view.

10. An apparatus for assisting a maneuvering procedure of a vehicle, wherein the apparatus has been configured to implement a method as claimed in claim 1.
